(19) United States
(12) Patent Application Publication
(10) Pub. No.: US 2021/0131419 A1
(43) Pub. Date: May 6, 2021

(54) LIQUID TRANSPORT APPARATUS AND DISPENSER USING THE SAME

(71) Applicant: SAMSUNG ELECTRONICS CO., LTD., Suwon-si (KR)

(72) Inventor: Jongkeun KIM, Suwon-si (KR)

(21) Appl. No.: 16/939,481

(22) Filed: Jul. 27, 2020

(30) Foreign Application Priority Data
Nov. 6, 2019 (KR) 10-2019-0141218

(51) Int. Cl. F04B 43/12; F04B 53/16

(52) U.S. Cl. CPC F04B 43/12; F04B 53/16

(57) ABSTRACT

A liquid transport apparatus is provided. The liquid transport apparatus provided includes a tube configured to transport passage of a liquid, a body including an accommodating groove into which a portion of the tube is inserted, and a pressurizing member movably arranged inside the accommodating groove and configured to pressurize the tube. In the tube, a portion pressurized by the pressurizing member is compressed between the pressurizing member and an inner wall of the accommodating groove, and a gap in a liquid that flows is not formed.

### CROSS-REFERENCE TO RELATED APPLICATION

This application is based on and claims priority under 35 U.S.C. § 119 to Korean Patent Application No. 10-2019-0141218, filed on Nov. 6, 2019, in the Korean Intellectual Property Office, the disclosure of which is incorporated by reference herein in its entirety.

### BACKGROUND

### 1. Field

The disclosure relates to a liquid transport apparatus, and for example, to a liquid transport apparatus that repeats pressurizing and release of pressurizing continuously along sections of a tube, and thereby transports a liquid through the tube.

### 2. Description of Related Art

In general, a peristaltic pump refers to a pump that transports a liquid repeatedly in an exact amount to discharge a specific amount of the liquid per unit time. A liquid to be transported moves through a tube, and a pump head can transport an exact amount through a peristaltic operation imitating a physiological vowel movement.

In a conventional peristaltic pump, a rotor having a plurality of rollers rotates inside a pump head formed into a circular shape through a flexible tube, and the rollers and the pump head in a circular shape adhere to each other, and a compression operation is performed when the rotor rotates. Accordingly, a liquid is transported by pressure, and a flow of the liquid is performed by a method of pushing one side together with compression by the next roller.

However, when there were a plurality of rollers as above, there was a limitation in manufacturing a peristaltic pump in a small size. Also, as the structure became complex, there was a problem that there was a difficulty in the manufacturing process and maintenance.

Meanwhile, in the case of using one roller to manufacture a peristaltic pump in a small size, when the roller is located between a liquid inlet portion and a liquid discharge portion of a tube, a gap wherein any portion of the tube cannot be sufficiently compressed is generated in a moment. In this case, if external pressure is applied on the liquid inlet portion and the liquid discharge portion of the tube, the flow of a liquid inside the tube is performed randomly in the same direction or in an opposite direction of the rotating direction of the roller, without being restricted by the rotating direction of the roller.

As a result, the peristaltic pump had a problem of significantly decreasing the efficiency of the pump because a transport amount was less than a predetermined transport amount.

### SUMMARY

Embodiments of the disclosure provide a liquid transport apparatus having a compact and simple structure, and which fundamentally blocks and/or avoids generation of a gap wherein a liquid may flow in a portion wherein a tube is compressed when the tube is pressurized for transport of the liquid, and can thereby maintain the transport amount of the liquid to the maximum.

Embodiments of the disclosure provide a liquid transport apparatus including a tube comprising a transport passage of a liquid, a body including an accommodating groove into which a portion of the tube is inserted, and a pressurizing member movably arranged inside the accommodating groove and is configured to pressurize the tube, wherein, in the tube, a portion pressurized by the pressurizing member is compressed between the pressurizing member and an inner wall of the accommodating groove. A gap in which a liquid flows is not formed.

The accommodating groove may include a first groove portion into which a first section of the tube into which a liquid is introduced and a third section of the tube from which a liquid is discharged is inserted, and a second groove portion into which a second section of the tube connecting the first and third sections of the tube with each other is inserted, and in a portion wherein the first and second groove portions are connected, first and second rounded portions which face each other and project toward the inner side of the accommodating groove may be formed.

The pressurizing member may further include a circular portion configured to pressurize the second section of the tube, and an extension portion extending on one side of the circular portion (e.g., a teardrop or lachrymiform shape) and configured to pressurize portions of the tube in locations corresponding to each of the first and second rounded portions.

The extension portion may be formed of a shape that becomes gradually narrower farther from the circular portion. In this case, the extension portion may be formed of a wedge shape.

The extension portion may be formed of a length capable of moving in the first and second groove portions alternatingly at the time of driving of the pressurizing member.

The pressurizing member may be driven along a closed-loop trajectory of a non-circular shape inside the accommodating groove.

The liquid transport apparatus of the disclosure may further include a rotating member configured to transmit power generated at an actuator to the pressurizing member.

The rotating member may include a cylindrical portion rotatably inserted into the body, and a connection projection provided on one surface of the cylindrical portion and eccentric with a center of the cylindrical part, wherein the connection projection may be connected to the concentric center of the cylindrical portion of the pressurizing member.

On the extension portion of the pressurizing member, a first sliding projection slidably inserted into a first sliding groove on the bottom of the accommodating groove may be provided.

The first groove portion of the accommodating groove may have a circular shape, the second groove portion of the accommodating groove may extend from one side of the first accommodating groove and may be in the shape of a straight line, and the sliding projection may be arranged in parallel with the second groove portion.

The liquid transport apparatus of the disclosure may further include a cover that separably coupled to the body and covering the accommodating groove, wherein, on the cover, a second sliding groove corresponding to the first sliding groove may be provided, and on the extension portions of the pressurizing member, a second sliding projection slidably inserted into the second sliding groove may be provided.

The first and second sliding grooves may be symmetrical with each other, and may have the same length.

The tube may be inserted between the side surface of the pressurizing member and the inner wall of the accommodating groove in an adhered state.

Also, the tube may comprise a silicon or urethane resin.

The pressurizing member may comprise a metallic or synthetic resin.

The disclosure can address the deficiencies of the related art by providing a liquid transport apparatus including a tube providing a transport passage of a liquid, a body including an accommodating groove including first and second groove portions, wherein first and second rounded portions projecting in a direction facing each other are formed between the first and second groove portions, and a pressurizing member movably arranged inside the accommodating groove and configured to pressurize the tube, wherein, the pressurizing member includes an extension portion having a wedge shape extending on one side and configured to pressurize portions of the tube in locations corresponding to each of the first and second rounded portions is provided, and wherein in the tube, a portion pressurized by the pressurizing member is compressed between the pressurizing member and an inner wall of the accommodating groove, and a gap in which a liquid flows is not formed.

The disclosure may provide a dispenser including the aforementioned liquid transport apparatus, a container in which a liquid is stored and which is connected to a liquid inlet portion of the tube, and a nozzle that is connected to a liquid discharge portion of the tube for discharging a liquid transported to the liquid discharge portion.

The dispenser may further include a case wherein the liquid transport apparatus, the container, and the nozzle are arranged on the inner side.

The dispenser may further include a case wherein the liquid transport apparatus and the nozzle are arranged on the inner side, and the container is separably coupled to the outer side.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a perspective view illustrating an example liquid transport apparatus according to an embodiment of the disclosure;

FIG. 2 is an exploded perspective view illustrating an example liquid transport apparatus according to an embodiment of the disclosure;

FIG. 3 is a plan view illustrating the body of an example liquid transport apparatus according to an embodiment of the disclosure;

FIG. 4 is a plan view illustrating the cover of an example liquid transport apparatus according to an embodiment of the disclosure;

FIG. 5 is a plan view illustrating an example liquid transport apparatus without the cover according to an embodiment of the disclosure;

FIG. 6A is a plan view illustrating an example process in which a pressurizing member is interlocked with rotation of a rotating member according to an embodiment of the disclosure;

FIG. 6B is a plan view illustrating an example process in which a pressurizing member is interlocked with rotation of a rotating member according to an embodiment of the disclosure;

FIG. 6C is a plan view illustrating an example process in which a pressurizing member is interlocked with rotation of a rotating member according to an embodiment of the disclosure;

FIG. 6D is a plan view illustrating an example process in which a pressurizing member is interlocked with rotation of a rotating member according to an embodiment of the disclosure;

FIG. 7A is a plan view illustrating an example process in which some sections of a tube are pressurized and released from pressurization by a pressurizing member driven and a liquid is transported through the tube according to an embodiment of the disclosure;

FIG. 7B is a plan view illustrating an example process in which some sections of a tube are pressurized and released from pressurization by a pressurizing member driven and a liquid is transported through the tube according to an embodiment of the disclosure;

FIG. 7C is a plan view illustrating an example process in which some sections of a tube are pressurized and released from pressurization by a pressurizing member driven and a liquid is transported through the tube according to an embodiment of the disclosure;

FIG. 7D is a plan view illustrating an example process in which some sections of a tube are pressurized and released from pressurization by a pressurizing member driven and a liquid is transported through the tube according to an embodiment of the disclosure;

FIG. 8 is a diagram illustrating an example dispenser including a liquid transport apparatus according to an embodiment of the disclosure; and

FIG. 9 is a diagram illustrating an example dispenser including a liquid transport apparatus according to an embodiment of the disclosure.

### DETAILED DESCRIPTION

Hereinafter, various example embodiments of the disclosure will be described with reference to the accompanying drawings. It should be noted that the disclosure is not limited to the example embodiments described herein, but may be implemented in various forms, and various modifications may be made to the various example embodiments of the disclosure. In the accompanying drawings, components may be illustrated in more enlarged sizes than their actual sizes for the convenience of description, and the proportion of each component may be exaggerated or reduced.

Terms such as “first,” “second” and the like may be used to describe various components, but the components are not intended to be limited by the terms. The terms are used simply to distinguish one component from another component. For example, a first component may be referred to as a second component, and a second component may be referred to as a first component in a similar manner, without departing from the scope of the disclosure.

Singular expressions include plural expressions, unless clearly indicated to be otherwise in context. In addition, terms such as “include” and “have/has” should be understood as designating that there are such characteristics, numbers, steps, operations, elements, components or a combination thereof described in the specification, and the terms may be interpreted to denote that one or more of other characteristics, numbers, steps, operations, elements, components or a combination thereof may be added.

Further, terms used in the various example embodiments of the disclosure may be interpreted as meanings generally known to those of ordinary skill in the art described in the disclosure, unless defined differently in the disclosure.

Hereinafter, the liquid transport apparatus according to example embodiments of the disclosure will be described in greater detail with reference to the drawings.

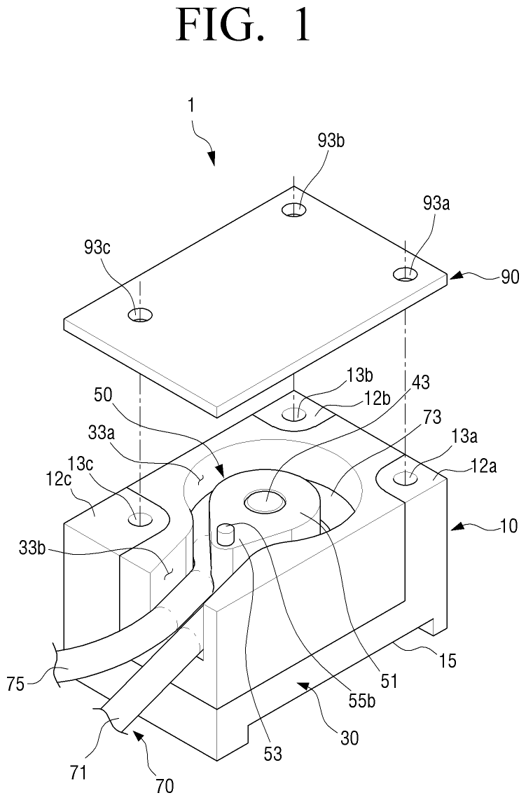

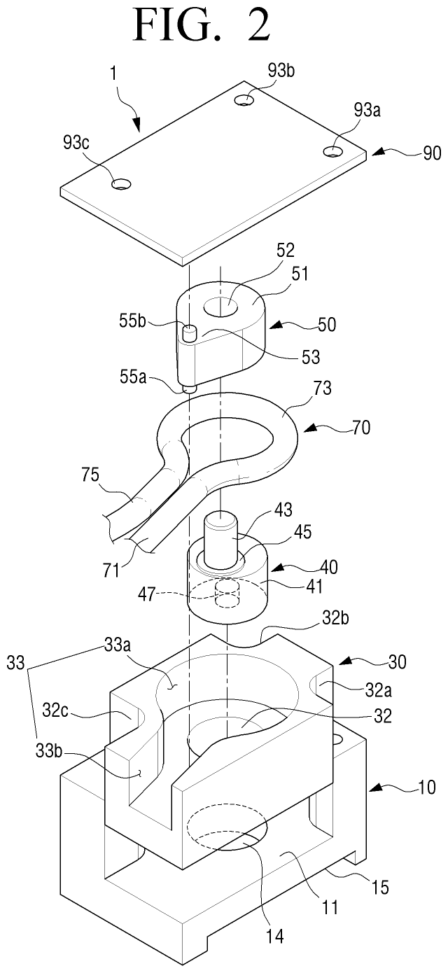

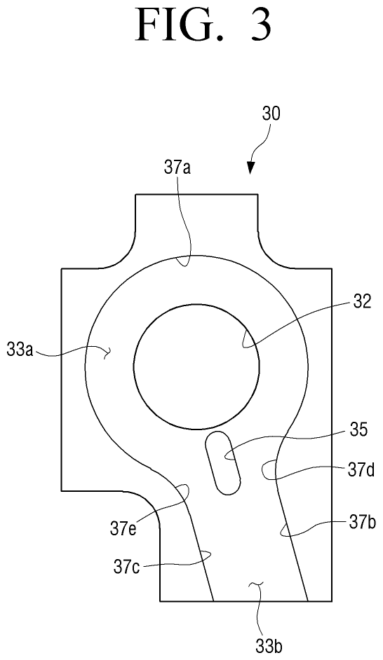

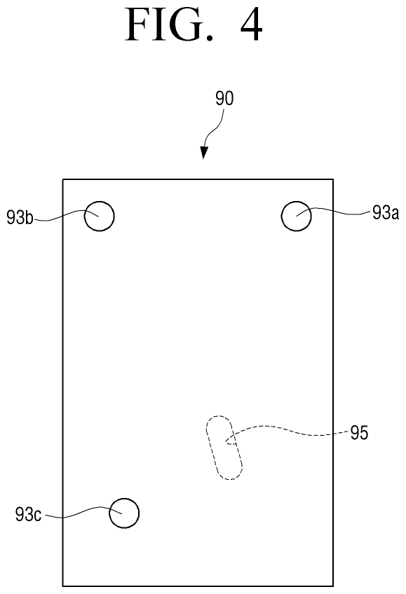

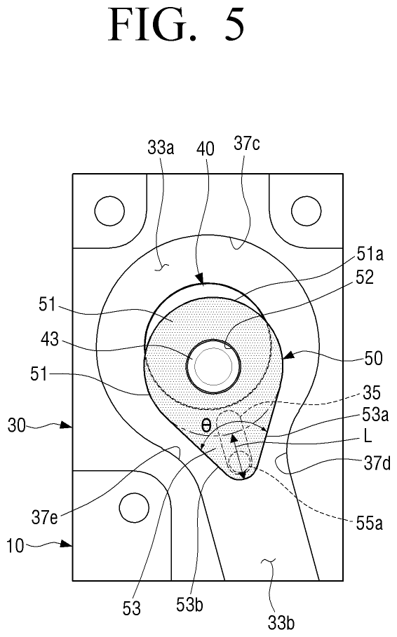

FIG. 1 is a perspective view illustrating an example liquid transport apparatus according to an embodiment of the disclosure, FIG. 2 is an exploded perspective view illustrating an example liquid transport apparatus according to an embodiment of the disclosure, FIG. 3 is a plan view illustrating a body of an example liquid transport apparatus according to an embodiment of the disclosure, FIG. 4 is a plan view illustrating a cover of an example liquid transport apparatus according to an embodiment of the disclosure, and FIG. 5 is a plan view of an example liquid transport apparatus with the cover removed according to an embodiment of the disclosure.

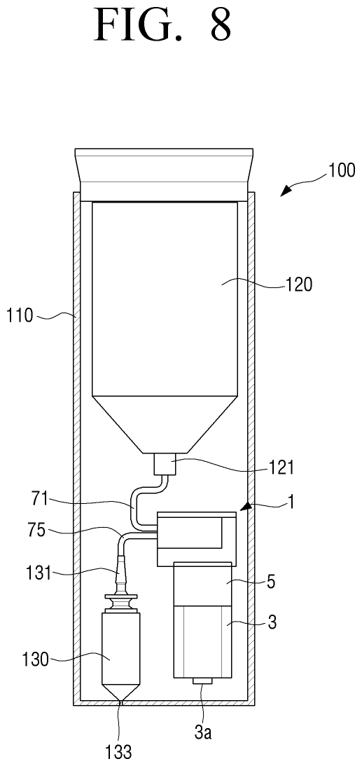

Referring to FIG. 1 and FIG. 2, a liquid transport apparatus 1 according to an embodiment of the disclosure may include a body, a rotating member 40 that is rotatably driven by driving force generated by an actuator 3 (refer to FIG. 8), a pressurizing member 50 that is driven while being interlocked with rotation of the rotating member 40 and showing a regular trajectory, and a tube 70 including a material that is flexible and restorable (e.g., a synthetic resin) that transports a liquid by change of internal pressure as some sections are sequentially pressurized by the pressurizing member 50 driven. Also, the liquid transport apparatus 1 according to an embodiment of the disclosure may further include a cover 90 covering the top portion of a base 10.

The body may include a base 10 to which the actuator 3 (refer to FIG. 8) can be coupled, and a guide part 30 that is fixed to the base 10. In the body, the base 10 and the guide part 30 are formed as separate components in consideration of convenience of manufacture, but the disclosure is not limited thereto, and the base 10 and the guide part 30 may be formed integrally.

The actuator 3 may be fixed to the base 10 through a connection member 5 (refer to FIG. 8). In this case, the connection member 5 may perform a role of connecting the actuator 3 and the base 10 with each other, but the disclosure is not limited thereto, and the connection member 5 may include a reducer structure for reducing the speed of driving force generated at the actuator 3 (e.g., the rotating speed of the driving axis of the actuator).

Any one of, for example, and without limitation, a servo motor, a stepping motor, a brushless motor, a brushless DC (BLDC) motor, a synchronous motor, a geared motor, an ultrasonic motor, or the like, may be applied to the actuator 3.

On one side of the base 10, a coupling groove 15 to which the connection member 5 is coupled may be formed. The size or shape of the coupling groove 15 may be formed to correspond to the size or shape of the connection member 5 coupled to the coupling groove 15.

On the other side of the base 10, a seating surface 11 on which the guide part 30 is seated may be formed, and on some corners among a plurality of corners of the seating surface 11, coupling projections 12a, 12b, 12c may be projectingly formed of a specific length. In this case, the length of the plurality of coupling projections 12a, 12b, 12c may be a sufficient length that will not make the guide part 30 easily separated in case the guide part 30 is coupled to the base 10 (e.g., a length approximately corresponding to the height of the guide part 30).

On the upper ends of the plurality of coupling projections 12a, 12b, 12c, fastening holes 13a, 13b, 13c may be respectively formed. The plurality of fastening holes 13a, 13b, 13c may correspond to the plurality of fastening holes 93a, 93b, 93c formed on the cover 90 covering the top portion of the base 10. Accordingly, the cover 90 may be separably coupled to the top portion of the base 10 through a plurality of screws (not shown) fastened to the plurality of fastening holes 13a, 13b, 13c; 93a, 93b, 93c.

On the base 10, a first penetrating hole 14 in which the rotating member 40 is rotatably arranged may be formed. As the first penetrating hole 14 is formed to penetrate the seating part of the base 10, the bottom surface of the rotating member 40 may be exposed to the side of the actuator 3. Accordingly, the driving axis 3a (refer to FIG. 8) of the actuator 3 may be fixedly coupled to a fixing groove 47 formed on the bottom surface of the rotating member 40.

On the side part of the guide part 30, a plurality of coupling grooves 32a, 32b, 32c to which the plurality of coupling projections 12a, 12b, 12c of the base 10 are respectively coupled may be formed. In order that the guide part 30 can be fixed to the base 10, the plurality of coupling projections 12a, 12b, 12c of the base 10 may be coupled to the plurality of coupling grooves 32a, 32b, 32c of the guide part 30 in a pressurized state.

Referring to FIGS. 2 and 3, on the guide part 30, an accommodating groove 33 for accommodating the pressurizing member 50 and the tube 70 are formed. The accommodating groove 33 may include a first groove portion 33a and a second groove portion 33b that communicate with each other.

The first groove portion 33a may be formed to be an approximately circular shape. The second section 73 of the tube 70 accommodated in the first groove portion 33a is arranged to form an approximately circular shape along the shape of the first groove portion 33a while surrounding the pressurizing member 50. In this case, the tube 70 may be arranged in a state of being jammed between the first inner wall 37c of the first groove portion 33a and the outer circumferential surface 51a (refer to FIG. 5) of the circular portion 51 of the pressurizing member 50 and adhered.

The second groove portion 33b may extend from one side of the first groove portion 33a and may be formed in an approximately straight line. In the second groove portion 33b, the first section 71 and the third section 75 of the tube 70 may be accommodated. Also, the second groove portion 33b may include second and third inner walls 37b, 37c facing each other.

Between the first and second inner walls 37a, 37b, a first rounded part 37d may be formed, and between the first and third inner walls 37a, 37c, a second rounded part 37e may be formed.

The first and second rounded parts 37d, 37e may pressurize the tube 70 by the driving of the pressurizing member 50. Also, the first and second rounded parts 37d, 37e may respectively be formed to project toward the inner side of the accommodating groove 33. In this case, the degree of projection of the first and second rounded parts 37d, 37e may be determined by the curvatures of the first and second rounded parts 37d, 37e. The curvatures of such first and second rounded parts 37d, 37e may be formed as curvatures by which the tube 70 is not broken or damaged when the tube 70 is pressurized by the pressurizing member 50.

In the guide part 30, a second penetrating hole 32 into which the rotating member 40 is rotatably inserted may be formed on the bottom of the accommodating groove 33. The second penetrating hole 30 may be arranged concentrically with the first penetrating hole 14 of the base 10, and may be formed to have the same diameter as the diameter of the first penetrating hole 14. Accordingly, in the rotating member 40, the cylindrical part 41 may be rotatably inserted into the first and second penetrating holes 14, 32. In this case, the bottom part of the cylindrical part 41 may be located inside the first penetrating hole 14, and at the same time, the upper part may be located inside the second penetrating hole 32.

Also, in the guide part 30, the first sliding groove 35 may be formed on the bottom of the accommodating groove 33. The first sliding groove 35 is for guiding the driving of the pressurizing member 50, and the first sliding projection 55a (refer to FIG. 2) of the pressurizing member 50 may be slidably inserted into it.

The first sliding groove 35 may be formed in a straight line having a specific length. Also, the first sliding groove 35 may be arranged in a direction in parallel with the second groove portion 33b. The arrangement direction of the first sliding groove 35 may influence the driving trajectory of the pressurizing member 50.

For example, in case the first sliding groove 35 is arranged in a direction in parallel with the second groove portion 33b, the pressurizing member 50 may be driven to sequentially pressurize the first to third sections 71, 73, 75 while showing a closed-loop trajectory of a non-circular shape in a clockwise direction or a counter-clockwise direction. In this case, the parts of the first section 71 and the third section 75 pressurized by the pressurizing member 50 may be limited to parts adjacent to the first rounded part 37d and the second rounded part 37e, respectively.

The parts of the first section 71 and the third section 75 pressurized by the extension portion 53 of the pressurizing member 50 may increase or decrease according to the length L of the extension portion 53 (refer to FIG. 8) of the pressurizing member 50.

A driving force generated by the actuator 3 is applied to the rotating member 40, and the rotating member 40 transmits the driving force to the side of the pressurizing member 50 such that the pressurizing member 50 is driven while showing a specific trajectory in a horizontal direction of the driving axis.

The rotating member 40 may include a cylindrical part 41 that is rotatably coupled to the first and second penetrating holes 14, 32, and a connection projection 43 formed in a location that is eccentric with the rotation center of the cylindrical part on the top surface of the cylindrical part 41.

The connection projection 43 may be rotatably inserted into the insertion hole 52 of the pressurizing member 50. Also, around the lower end of the connection projection 43, a stepped bump 45 may be formed.

When the connection projection 43 is inserted into the insertion hole 52 of the pressurizing member 50, the bottom surface of the pressurizing member 50 contacts only the top surface of the stepped bump 45. The stepped bump 45 restricts contact between the bottom surface of the pressurizing member 50 and the top surface of the rotating member 40 and can thereby minimize and/or reduce the contacting area between the rotating member 40 and the pressurizing member 50. Accordingly, frictional force that may occur between the rotating member 40 and the pressurizing member 50 is minimized, and a factor inhibiting the driving of the pressurizing member 50 can be prevented and/or reduced in advance.

On the bottom surface of the rotating member 40, a fixing groove 47 to which the driving axis 3a of the actuator 3 is fixedly coupled may be formed. Accordingly, the rotating member 40 may rotate in the same direction as the driving axis of the actuator.

The pressurizing member 50 may include a circular portion 51 and an extension portion 53.

In the center of the circular portion 51, an insertion hole 52 to which the connection projection 43 of the rotating member 40 is coupled may be formed.

The outer circumferential surface 51a (refer to FIG. 5) of the circular portion 51 may be formed as a curved surface, and both side surfaces 53a, 53b of the extension portion 53 may be formed as planes. The both side surfaces 53a, 53b of the extension portion are respectively continued to the outer circumferential surface 51a of the circular portion 51.

Also, the outer circumferential surface 51a of the circular portion may pressurize the second section of the tube 70. The both side surfaces 53a, 53b of the extension portion may pressurize portions of the tube 70 that are adjacent to the first and second rounded portions 37d, 37e of the accommodating groove 33.

Referring to FIG. 5, the extension portion 53 may be an approximately wedge shape, and may be formed integrally on one side of the circular portion 51. Such a shape of the extension portion 53 is based on consideration that a gap (or a passage) wherein a liquid can flow should be prevented and/or reduce from occurring inside the tube 70 on a point being pressurized, when some sections of the tube 70 are continuously pressurized while the pressurizing member 50 is driven.

For the extension portion 53 formed of an approximately wedge shape as above, the length L or the angle θ of the extension portion 53 may be appropriately adjusted according to the size of the accommodating groove 33, the degree of projection or the curvatures of the first and second rounded parts 37d, 37e, the size of the external diameter of the tube 70, etc., and accordingly, it may be adjusted such that a gap inside the tube does not occur on a pressurized point of the tube that is being pressurized by the pressurizing member 50.

On the bottom surface of the extension portion 53, a first sliding projection 55a may be formed, and on the top surface, a second sliding projection 55b may be formed. The first and second sliding projections 55a, 55b may be formed symmetrically with each other.

The first sliding projection 55a is slidably inserted into the first sliding groove 35 of the guide part 30. The second sliding projection 55b is slidably inserted into the second sliding groove 95 (refer to FIG. 4) formed on the bottom surface of the cover 90. In this case, the second sliding groove 95 may be arranged in a location corresponding to the first sliding groove 35, and may be formed of the same shape as the first sliding groove 35.

The pressurizing member 50 is interlocked with rotation of the rotating member 40 and is driven while showing a specific closed-loop trajectory. While the pressurizing member 50 is driven, the pressurizing member 50 may sequentially pressurize from a portion of the first section 71 of the tube 70 to some portions of the second section 73 and the third section 75 and then release the pressurization, and thereby transport a liquid inside the tube 70 from the side of the first section 71 to the side of the third section 75.

The pressurizing member 50 may include a metallic material having specific rigidity and durability, or include a synthetic resin. In case the pressurizing member 50 includes a synthetic resin, the synthetic resin may be a polyamide (PA) nylon resin having specific rigidity, durability, and elasticity. In case the pressurizing member 50 includes a PA nylon resin, the pressurizing member 50 has its own elasticity when pressurizing the tube 70, and thus damage to the tube 70 by pressure can be prevented and/or reduced.

The tube 70 may include a material having elasticity to a degree such that its shape can be restored when it is released from pressurization after being pressurized by the pressurizing member 50 (e.g., a silicon or urethane resin).

The tube 70 is formed to have an external diameter to a degree such that a portion not pressurized by the pressurizing member 50 in the accommodating groove 33 can be inserted in a pressurized state between the inner wall of the accommodating groove 33 and the outer circumferential surface of the pressurizing member 50. This is for preventing the phenomenon that the tube 70 flows to the upper side and the lower side of the accommodating groove 33 by the driving of the pressurizing member 50.

The cover 90 is separably coupled to the top portion of the base 10 through a plurality of screws. In this case, the cover 90 may cover the accommodating groove 33 of the guide part 30.

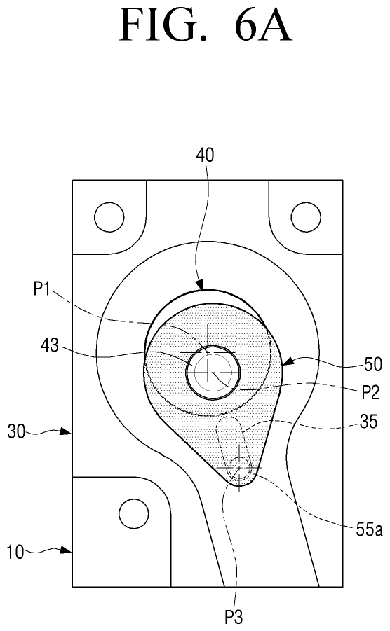

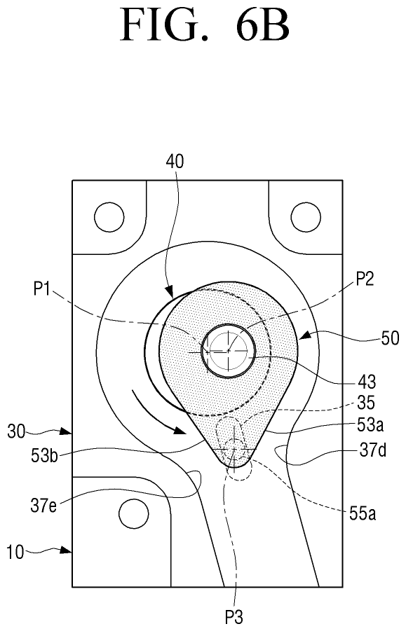

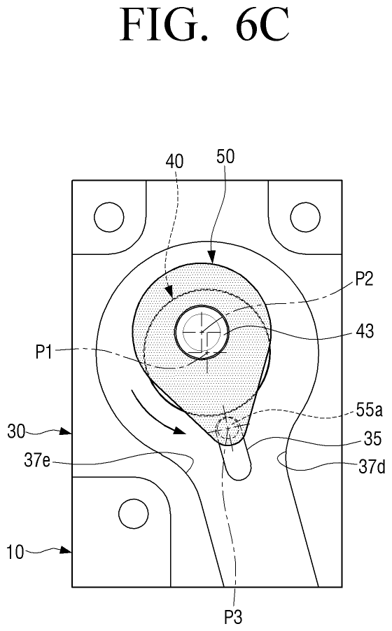

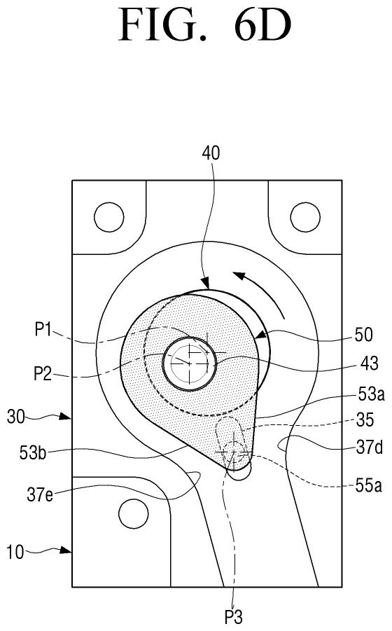

Hereinafter, driving of the pressurizing member 50 that is interlocked with the rotating member 40 according to the driving of the rotating member 40 will be described with reference to FIGS. 6A, 6B, 6C and 6D (which may be referred to hereinafter as FIGS. 6A to 6D). FIGS. 6A to 6D are plan views sequentially illustrating an example process wherein the pressurizing member is interlocked with rotation of the rotating member according to an embodiment of the disclosure.

Referring to FIG. 6A, the initial location of the pressurizing member 50 can be defined as a state wherein the first to third connection points P1, P2, P3 are arranged in a straight line for the convenience of explanation. In this case, the extension portion 53 of the pressurizing member 50 is located between the first and second rounded parts 37d, 37e. However, the initial location of the pressurizing member 50 does not have to be necessarily limited to the aforementioned arrangement.

The first connection point P1 may correspond to the center point of the driving axis 3a of the actuator 3 that is rotatably inserted into the fixing groove 47 of the rotating member 40. The second connection point P2 may correspond to the center point of the connection projection 43 of the rotating member 40 rotatably inserted into the insertion hole 52 of the pressurizing member 50. The third connection point P3 may correspond to the center point of the first and second sliding projections 55a, 55b of the pressurizing member 50 that are slidably inserted respectively into the first sliding groove 35 of the guide part 30 and the second sliding groove 95 of the cover 90. In this case, the first and second sliding projections 55a, 55b are arranged concentrically.

In this case, the second connection point P2 may be located on the lower side of the first connection point P1, and the third connection point P3 may be located in an approximately lower end part of the first and second sliding grooves 35, 95.

Referring to FIG. 6B, when the rotating member 40 receives driving force from the actuator 3 and rotates in a counter-clockwise direction, the pressurizing member 50 is driven while being interlocked with the rotating member 40.

The pressurizing member 50 interlocked with the rotating member moves to the right side of the first groove portion 33a from the initial location as in FIG. 6B. Here, the first and second sliding projections 55a, 55b move in the upper direction along the first and second sliding grooves 35, 95, and the circular portion 51 of the pressurizing member 50 rotates by a specific angle to the right side with the first and second sliding projections 55a, 55b at the center.

The extension portion 53 of the pressurizing member 50 is located in a location that is not completely out of the space between the first and second rounded parts 37d, 37e. Meanwhile, the interval between the right side surface 53a of the extension portion 53 and the first rounded part 37d may become narrower than the interval between the left side surface 53b of the extension portion 53 and the second rounded part 37e.

In this case, the second connection point P2 may move to the right side of the first connection point P1, and the third connection point P3 may be located in an approximately middle portion of the first and second sliding grooves 33, 95.

Referring to FIG. 6C, the pressurizing member 50 is interlocked with the rotating member 40 and continuously moves in a counter-clockwise direction.

The pressurizing member 50 moves from the right side of the first groove portion 33a to the upper side as in FIG. 6C. The first and second sliding projections 55a, 55b move to the upper direction along the first and second sliding grooves 35, 95, and the circular portion 51 of the pressurizing member 50 rotates by a specific angle to the left side with the first and second sliding projections 55a, 55b at the center.

The extension portion 53 of the pressurizing member 50 is located in a location that is completely out of the space between the first and second rounded parts 37d, 37e.

In this case, the second connection point P2 may move to the upper side of the first connection point P1, and the third connection point P3 may be located in an approximately upper end portion of the first and second sliding grooves 33, 95.

Referring to FIG. 6D, when the rotating member 40 receives driving force from the actuator 3 and continuously rotates in a counter-clockwise direction, the pressurizing member 50 is driven while being interlocked with the rotating member 40.

The pressurizing member 50 interlocked with the rotating member moves from the upper side of the first groove portion 33a to the left side. The first and second sliding projections 55a, 55b move to the lower direction along the first and second sliding grooves 35, 95, and the circular portion 51 of the pressurizing member 50 rotates by a specific angle to the left side with the first and second sliding projections 55a, 55b at the center.

The extension portion 53 of the pressurizing member 50 is located in a location that is not completely out of the space between the first and second rounded parts 37d, 37e. In this case, the interval between the left side surface 53b of the extension portion 53 and the second rounded part 37e may become narrower than the interval between the right side surface 53a of the extension portion 53 and the first rounded part 37d.

In this case, the second connection point P2 may move to the left side of the first connection point P1, and the third connection point P3 may be located in an approximately middle portion of the first and second sliding grooves 33, 95.

When the pressurizing member 50 continuously rotates in a counter-clockwise direction by the rotating member 40 in a location as in FIG. 6D, the pressurizing member 50 is restored to the initial location as in FIG. 6A. As above, the pressurizing member 50 may be driven while showing a closed-loop trajectory in a counter-clockwise direction.

It is described that the rotating member 40 rotates in a counter-clockwise direction. However, the disclosure is not limited thereto, and in case the driving axis 3a of the actuator 3 rotates in a clockwise direction, the rotating member 40 may rotate in a clockwise direction, and the pressurizing member 50 is also interlocked with the rotating member 40 and is driven while showing a moving trajectory along a clockwise direction.

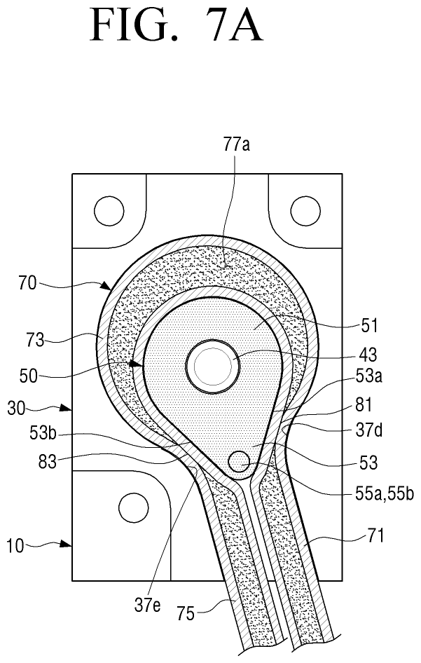

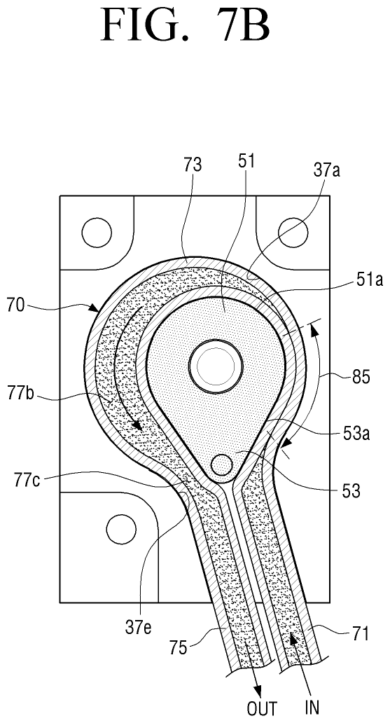

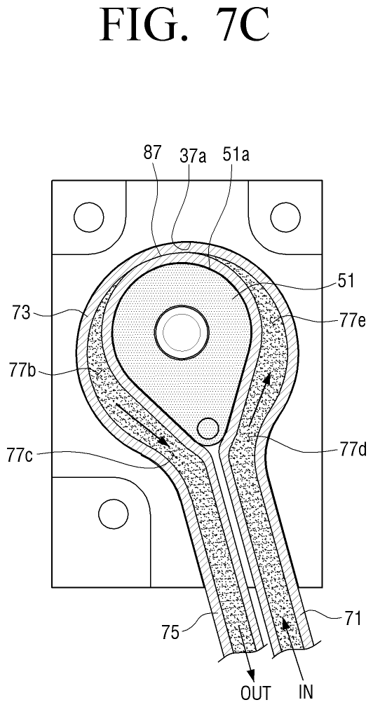

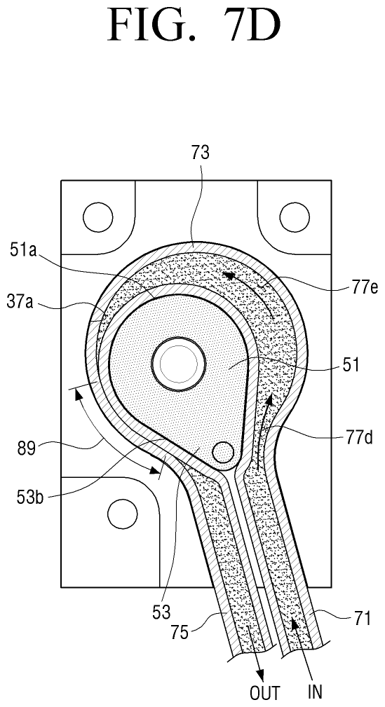

Hereinafter, with reference to FIGS. 7A, 7B, 7C and FIG. 7D (which may be referred to hereinafter as FIGS. 7A to 7D), a process wherein the tube 70 is pressurized by the aforementioned driving of the pressurizing member 50 in a counter-clockwise direction, and a liquid is absorbed from the side of the first section 71 of the tube and is transported to the third section 75 through the second section 73 of the tube will be sequentially described by way of illustrative, non-limiting, example.

In the disclosure, to the end part of the first section 71 of the tube 70, a specific container 120 (refer to FIG. 8) storing a liquid may be connected, and on the end part of the third section 75, a nozzle 130 (refer to FIG. 8) that may discharge a liquid transported from the side of the first section 71 to the side of the third section 75 through the second section 73 along the tube 70 may be arranged.

FIG. 7A to FIG. 7D are plan views of random sequential locations during a continuous process wherein some sections of the tube are pressurized and released from pressurization by the pressurizing member driven and a liquid is transported through the tube.

Referring to FIG. 7A, the pressurizing member 50 may pressurize some portions of the tube 70 in the initial location. In this case, the portions of the tube 70 pressurized by the extension portion of the pressurizing member 50 may be a portion of the tube 70 between the right side surface 53a of the extension portion 53 and the first rounded part 37d of the accommodating groove 33, and a portion of the tube 70 between the left side surface 53b of the extension portion 53 and the second rounded part 37e of the accommodating groove 33.

When the actuator 3 is driven, the driving axis 3a of the actuator 3 rotates at a specific rotating speed in a counter-clockwise direction. The rotating member 40 rotates together with the driving axis 3a in a counter-clockwise direction, and thereby drives the pressurizing member 50.

Referring to FIG. 7B, the pressurizing member 50 in the initial location is interlocked with the rotating member 40 and moves to the left side inside the first groove portion 33a of the accommodating groove. In this case, while the pressurizing member 50 moves from the initial location to the location illustrated in FIG. 7B, the pressurizing member 50 continuously pressurizes some sections 85 in the second section 73 of the tube 70 toward the side of the inner wall of the accommodating groove 33.

In the sections of the tube 70 that are pressurized, as the tube 70 may be completely compressed, a gap wherein a liquid can flow does not occur inside the tube 70. As the reason that a gap does not occur as above, there is the operation that the right side surface 53a of the extension portion 53 continuously pressurizes the tube 70 and the outer circumferential surface 51a of the circular portion 51 gradually pressurizes the tube 70 together with the right side surface 53a of the extension portion 53 while the pressurizing member 50 is driven from the initial location to the location illustrated in FIG. 7B.

While the pressurizing member 50 moves from the initial location to the right side of the accommodating groove 33 illustrated in FIG. 7B pressurizing the tube, in the space inside the second section 73 of the tube, the space adjacent to the side of the first section 71 may become gradually narrower and the space adjacent to the side of the third section 75 may become extended. Accordingly, the liquid located inside the second section 73 is transported to the side adjacent to the third section 75 by pressurizing force. Also, in a portion of the tube 77 corresponding to the second rounded part 37e not pressurized by the pressurizing member 50, a passage 77c through which the liquid can be transported from the second section 73 to the third section 75 may be secured.

At the same time, in the space inside the first section 71, the pressure of the space on the side adjacent to the second section 73 may become lower than the pressure on the side adjacent to the container 120. Accordingly, the liquid inside the first section 71 may be transported to a portion adjacent to the side of the second section 73.

Referring to FIG. 7C, the pressurizing member 50 is interlocked with the rotating member 40 continuously rotating in a counter-clockwise direction and moves to the upper side inside the first groove portion 33a of the accommodating groove 33. In this case, the pressurizing member 50 sequentially pressurizes from the right side portion of the second section 73 of the tube 70 to the center portion of the second section 73. Here, in some sections of the tube 70 that are pressurized, as the tube 70 is completely compressed, a gap wherein a liquid can flow does not occur inside the tube 70.

In this case, the remaining portions of the tube 70 not pressurized by the pressurizing member 50 excluding the center portion of the second section 73 of the tube 70 pressurized by the pressurizing member 50 are restored to their original forms by the elasticity of the tube itself, and passages 77b, 77c, 77d, 77e may be secured such that a liquid can be transported.

The liquid inside the second section 73 adjacent to the side of the third section 75 of the tube may be transported to the third section 75 through the passage 77c, and the liquid inside the first section 71 may be transported to the second section 73 adjacent to the first section 71 through the passage 77d.

Referring to FIG. 7D, the pressurizing member 50 is interlocked with the rotating member 40 continuously rotating in a counter-clockwise direction and moves from the upper side inside the first groove portion 33a of the accommodating groove 33 to the left side. In this case, the pressurizing member 50 sequentially pressurizes from the center portion of the second section 73 of the tube 70 to the left side portion of the second section 73. Here, in some sections of the tube 70 that are pressurized, as the tube 70 is completely compressed, a gap wherein a liquid can flow does not occur inside the tube 70.

The liquid in the left side portion of the second section 75 of the tube may be transported to the third section 75, and the liquid introduced into the first section 71 may be transported to the right side portion of the second section 73 through the passage 77d.

Then, the pressurizing member 50 is interlocked with the rotating member 40 continuously rotating in a counter-clockwise direction and moves to the initial location as in FIG. 7A.

The liquid transport apparatus 1 according to an embodiment of the disclosure fundamentally blocks occurrence of a gap wherein a liquid can flow inside a pressurized portion of the tube 70 that is being pressurized when the pressurizing member 50 is driven in a direction while showing a closed-loop trajectory, and can thereby perform control such that a liquid can be transported correctly in a desired direction of transport (the first section→the second section→the third section) through the tube 70.

The liquid transport apparatus 1 according to an embodiment of the disclosure may secure credibility in operation, and also has advantages that manufacture and maintenance are easy and the manufacturing cost can be reduced as it is formed of a simpler structure compared to the conventional technology.

FIG. 8 is a diagram illustrating an example dispenser including a liquid transport apparatus according to an embodiment of the disclosure.

Referring to FIG. 8, to the dispenser 100 according to an embodiment of the disclosure, the aforementioned liquid transport apparatus 1 can be applied.

The dispenser 100 may include a case 110, a container 120 storing a liquid, and a nozzle 130 for discharging a liquid outside the case 110.

On the inner side of the case 110, the liquid transport apparatus 1, the actuator 3, the connection member 5, the container 120, and the nozzle 130 may be arranged.

On the container 120, a liquid discharge port 121 connected to the first section 71 of the tube may be formed. Accordingly, a liquid stored inside the container 120 may be supplied to the liquid transport apparatus 1 through the first section 71 of the tube.

On one side of the nozzle 130, a liquid inlet port 131 connected to the third section 75 of the tube may be formed. Accordingly, the liquid transported from the liquid transport apparatus 1 may be supplied to the nozzle 130 through the third section 75 of the tube.

On the other side of the nozzle 130, a discharge opening 133 for discharging the liquid supplied from the liquid transport apparatus 1 by a specific amount may be formed. The discharge opening 133 communicates with the case 110, and may discharge the liquid outside the case 110.

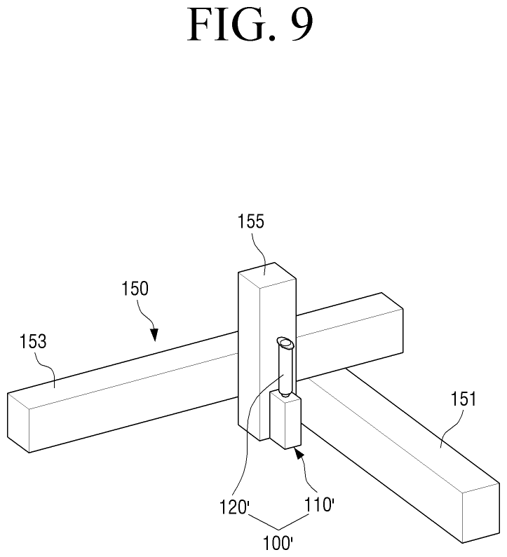

FIG. 9 is a diagram illustrating an example dispenser including a liquid transport apparatus according to an embodiment of the disclosure.

Referring to FIG. 9, the dispenser 100′ according to another example of the disclosure may include the aforementioned liquid transport apparatus 1.

The dispenser 100′ is similar to the aforementioned dispenser 100, but there is a difference in that the container 120′ is arranged in an exposed state on the outer side of the case 110′.

The dispenser 100′ may be used while being coupled to a three-axis moving apparatus 150 so that it can move to the X axis, Y axis, and Z axis and discharge a liquid in a specific location.

In this case, in the three-axis moving apparatus 150, a first driving part 151 moving along the X axis, a second driving part 153 moving along the Y axis, and a third driving part 155 moving along the Z axis may be connected with one another in a state of being able to move in each direction.

For example, the dispenser 100′ may discharge a liquid or a liquid-phase material having specific viscosity to a specific location on a printed circuit board.

The dispenser 100 illustrated in FIG. 8 may also be used while being coupled to the three-axis moving apparatus 150 as the dispenser 100′ illustrated in FIG. 9.

While the disclosure has been illustrated and described with reference to various example embodiments thereof, it will be understood that the various example embodiments are intended to be illustrative, not limiting. It will be further understood by one of ordinary skill in the art that various changes in form and detail may be made without departing from the true spirit and full scope of the disclosure, including the appended claims and their equivalents.

What is claimed is:

1. A liquid transport apparatus comprising:
a tube configured to transport passage of a liquid;
a body including an accommodating groove into which a portion of the tube is inserted; and
a pressurizing member movably arranged inside the accommodating groove and configured to pressurize the tube,
wherein, in the tube, a portion pressurized by the pressurizing member is configured to be compressed between the pressurizing member and an inner wall of the accommodating groove, wherein a gap in a liquid that flows is not formed.

2. The liquid transport apparatus of claim 1,
wherein the accommodating groove comprises:
a first groove portion accommodating a first section of the tube configured to receive a liquid and a third section of the tube configured to discharge the liquid; and
a second groove portion accommodating a second section of the tube connecting the first and third sections of the tube, and
first and second rounded portions facing each other and projecting toward an inner side of the accommodating groove provided in a region where the first and second groove portions are connected.

3. The liquid transport apparatus of claim 2,
wherein the pressurizing member further comprises:
a circular portion configured to pressurize the second section of the tube; and
an extension portion extending from one side of the circular portion and configured to pressurize portions of the tube in locations corresponding to each of the first and second rounded portions.

4. The liquid transport apparatus of claim 3,
wherein the extension portion has a shape that becomes gradually narrower as it extends farther from the circular portion.

5. The liquid transport apparatus of claim 3,
wherein the extension portion has a wedge shape.

6. The liquid transport apparatus of claim 3,
wherein the extension portion has a length capable of moving in the first and second groove portions alternatingly while driving of the pressurizing member.

7. The liquid transport apparatus of claim 3,
wherein the pressurizing member is configured to be driven along a closed-loop trajectory of a non-circular shape inside the accommodating groove.

8. The liquid transport apparatus of claim 7, further comprising:
a rotating member configured to transmit power generated at an actuator to the pressurizing member.

9. The liquid transport apparatus of claim 8,
wherein the rotating member comprises:
a cylindrical portion rotatably inserted into the body; and
a connection projection provided on one surface of the cylindrical portion and is eccentric with respect to a center of the cylindrical part, and
wherein the connection projection is connected to a concentric center of the cylindrical part of the pressurizing member.

10. The liquid transport apparatus of claim 9,
wherein, a first sliding projection slidably inserted into a first sliding groove provided on a bottom of the accommodating groove is provided on the extension portion.

11. The liquid transport apparatus of claim 10,
wherein the first groove portion of the accommodating groove comprises a circular shape,
the second groove portion of the accommodating groove extends from one side of the first groove portion and has a shape of a straight line, and
the sliding projection is arranged in parallel with the second groove portion.

12. The liquid transport apparatus of claim 11, further comprising:
a cover that separably coupled to the body to cover the accommodating groove,
wherein, on the cover, a second sliding groove corresponding to the first sliding groove is provided, and
on the extension portion of the pressurizing member, a second sliding projection slidably inserted into the second sliding groove is provided.

13. The liquid transport apparatus of claim 12,
wherein the first and second sliding grooves are symmetrical with each other, and have a same length.

14. The liquid transport apparatus of claim 1,
wherein the tube is inserted between a side surface of the pressurizing member and the inner wall of the accommodating groove in an adhered state.

15. The liquid transport apparatus of claim 1,
wherein the tube comprises a silicon or urethane resin.

16. The liquid transport apparatus of claim 1,
wherein the pressurizing member comprises a metallic or synthetic resin.

17. A liquid transport apparatus comprising:
a tube configured to transport passage of a liquid;
a body including an accommodating groove including first and second groove portions, and first and second rounded portions projecting in a direction of facing each other between the first and second groove portions; and
a pressurizing member movably arranged inside the accommodating groove and configured to pressurize the tube,
wherein, the pressurizing member includes an extension portion having a wedge shape extending on one side and is configured to pressurize portions of the tube in locations corresponding to each of the first and second rounded portions, and
a portion of the tube pressurized by the pressurizing member is configured to be compressed between the pressurizing member and an inner wall of the accommodating groove, wherein a gap in a liquid that flows is not formed.

18. A dispenser comprising:
the liquid transport apparatus comprising a tube configured to transport passage of a liquid, a body including an accommodating groove into which a portion of the tube is inserted and a pressurizing member movably arranged inside the accommodating groove and configured to pressurize the tube;
a container configured to store a liquid and connected to a liquid inlet portion of the tube; and
a nozzle connected to a liquid discharge portion of the tube and configured to discharge a liquid transported to the liquid discharge portion,
wherein, a portion of the tube pressurized by the pressurizing member is configured to be compressed between the pressurizing member and an inner wall of the accommodating groove, wherein a gap in a liquid that flows is not formed.

19. The dispenser of claim 18, further comprising:
a case in which the liquid transport apparatus, the container, and the nozzle are arranged.

20. The dispenser of claim 19, further comprising:
a case in which the liquid transport apparatus and the nozzle are arranged, wherein the container is separably coupled to an outer side.
